(19) United States
(12) Patent Application Publication
(10) Pub. No.: US 2004/0001909 A1
(43) Pub. Date: Jan. 1, 2004

(54) Process and two apparatuses for obtaining syrup of various sugars through an enzymatic extraction and with the use of resins, together with a new mixed system of evaporation and purification

(76) Inventors: Xavier Monge Yoder, Guayaquil (EC); Fernando Martinez Illingworth, Guayaquil (EC)

Correspondence Address: TOD R. NISSLE, P.C., P.O. Box 55630, Phoenix, AZ, 85078, US

(21) Appl. No.: 10/406,328

(22) Filed: Apr. 3, 2003

(30) Foreign Application Priority Data
Apr. 8, 2002 (EC) 02-4245

(51) Int. Cl. A23K 1/00

(52) U.S. Cl. 426/615

(57) ABSTRACT

The purpose and finality of the invention is obtaining sweetener syrup of various sugars, from fruit pulp. Subsequently these sugars can be suitable refined. The obtaining is with enzymes and resin, in an oxidant medium, with controlled acidity and using an Apparatus for extraction and an Apparatus for evaporation which are hereby been patented.

The technological sector which this invention refers to, is the Food Technology Sector, generally included in the field of Chemical Engineering, as a special area of the industrial processes using Unit Operations.

Prior technologies that may be useful for understanding this Process and Apparatus include many designs for industrial evaporators and filters as well as reactors capable of maintaining the mass of products in the process at a constant temperature and changing it in a controlled way.

Because of their special important in relation to this invention we will now describe four of the industrial machines of general use in Unit Operations, applied since many years ago to food technology, which also have application in the specialized process which patent is being hereby applied for. This section is included to demonstrate that this equipment is of general use and not specialized and does not exactly correspond to any of the Apparatus for which we are applying a patent. These four machines are described on literals A, B, C, and D, which follow:

A) We describe the Industrial Presses. These presses are machines comprising one or more chambers which purpose is to receive a mass, generally of vegetal or animal original, and using pressures that may even be very high, such as, for example, 600 atmospheres, they achieve the extraction of a product generally of a liquid or paste consistency, which may be the final product or may be an intermediate product for a subsequent industrial process. As an example, in the cacao industry many models of these presses, from a large number of suppliers, have been used.

Our invention does not include any of these presses, designed many years ago, but a press built specifically for the fruit extraction we have developed, with its characteristics of asepsis, pressure range and facilities for loading and unloading, which we have name “Apparatus II”.

B) We describe the treating tanks or industrial reactors for liquids or pastes. These tanks are vessels designed to contain a liquid or mass while it is treated at a controlled temperature, for which purpose they are frequently fitted with a jacket and also frequently need agitation for which they are generally fitted with motor-driven stirrers.

Our invention does not include any such tank reactors in its claims, since they are nothing new.

In the industry of cacao semi-finished products, tanks such as those are used for storing and treating the cacao paste.

C) We describe the filters that may be used in our process of extraction of fruit paste or juice. These industrial filters with one or more chambers, or greatly varied sizes, with or without stirring, are common in the food processing industries. Some even use vacuum or high pressures generated by high-pressure pumps.

Many of these filters could be selected from the equipment available to industries and be applied to the filtration of liquids or fuit pulp masses in a process such as the one we are patenting.

Our invention does not include any of this filtration equipment since several of them can be specified from the market and applied to the process we are patenting.

D) We describe now the equipment used for evaporation in industrial processes used in the food industry for processes similar to the one we are patenting. The most suitable evaporators seem to be of the falling film type. Generally this apparatus consist of several evaporators connected in series, name “effects”.

The liquid to be evaporated enters the first effect where it is partially evaporated going then, successively, to each of the following effects. The vapor generated in each one of the successive effects is used as heat source to evaporate the following effect, achieving in this way a considerable saving in energy utilization, which is particularly important in countries where energy is expensive and also achieving a more ecological operation, since much less energy is wasted, plant-wide.

In our invention, the last effect has been designed by us to be able to carry the evaporation to a high concentration level. Such equipment is described int his invention and it is named “Apparatus I”.

As prior documents and publications we can mention so many and so varied ones, that it is really not worthwhile to do it, since none of them constitutes the “last word” on this matter. The older ones are dated more than 30 years ago and in them there are comments regarding procedures similar in some aspects, but with results not equal in efficiency nor quality, to the ones experimented for this invention. The “old” technical problem has always been that the sugars in certain fruit juices, even though they can be noticed present many difficulties for being separated in an economical way. It is possible that none of them have reached the industrial process stage, as the one hereby described, because of those economical reasons.

In the given solution, this problem is solved at industrially acceptable costs. This process is achieved by means of an enzymatic and by-resin digestion of the fruit pulp in a suitable reactor which maintains the temperature and acidity appropriate for that activity, and then applying a filtration process before and during the evaporation to remove solids, obtaining a clean syrup. Such product is evaporated to reach the desired Brix degrees, which can be fairly high.

Concentrations up to 85 Brix degrees have been experimented on, which can be obtained provided the work is done with due care and patience.

We have attached a drawing of the Apparatus designed for this process which we are including for the purpose of this patent application. This is a machine that constitutes on evaporative effect, designed to work together with another or several evaporative effects in a chain.

The drawing is self-explanatory, consisting of a crystallizer-type evaporator, which purpose is not to crystalized but to evaporate wand which is assisted, as part of its design, by a recirculation pump, which also serves as the product discharge pump.

The best way of applying this invention consists in placing the pulp or fruit juice mixture in the reactor, heat it up to the desired temperature and treated it with the desired resins and enzymes, to achieve a first extraction. Subsequently the juice is filtered and evaporated though the necessary stages, including the final step in the patented Apparatus.

We consider evident that this invention has a direct industrial application, as presented above.

As one of the possible examples, we are going to describe in detail how the invention works, in regards to it procedure as well as its apparatus, for the extraction of syrup of various sugars from ripe banana pulp. This procedure must be regarded as an integral part of this invention. We have also experienced similar results using green banana.

For this purpose the ripe banana pulp was first extracted in a machine specifically designed and built for this use, which construction has been ordered and the corresponding Apparatus II satisfactory tested by us.

This apparatus, which for the purpose of this description we will call “Apparatus II”, consists of a chamber inside which the fruit with its peel is placed and it is sealed with its corresponding quick tightening bolts.

On one end of the machine there is a screen of fine mesh and its corresponding perforated support, for the outlet of the product. The support and screen are dis-assemblable, for cleaning.

On the other end there is a hydraulic piston of adjustable pressure, supported by the corresponding hydraulics equipment, which purpose is to extract the juice from the corresponding fruit pulp. Leaving practically all the peel and bagasse separated inside the cylinder. Subsequently, the same piston can discharge the bagasse under its own propulsion, through the discharge gate.

With this Apparatus II, which patent we are applying for, a very efficient separation of the useful portion from the fruit bagasse is achieved.

Under these conditions, the juice or pulp is received in a a suitable tank and it is heated with steam through the reactor's heat exchange surface, under continuous slow agitation. Additionally, by means of a high volume compressor, a continuous stream of hot air is blown and bubbles through the reactor and the exhaust air is conducted through a duct to an aroma collector, APV brand, which works at a low temperature and allows the+collection of the fruit's aromas. Once the aromas have been extracted it is necessary to reduce the mass temperature to 38 degrees Celsius.

These aromas can be subsequently used to improve the flavor of industrial fruit juices, although the latter is not part of these process.

Subsequently, keeping the pulp inside the suitable container, it is heated to the appropriate temperature and acidified to a pH between 3.5 and 7.5 and added a very small amount of anit-oxidant (from 0.5 to 3000 ppm). Also it is added from 2 to 3000 ppm of an absorbing resin. In this container the pulp or juice is digested for 1 to 84 hours. After this treatment, it is treated with from 0.1 to 1.7% of amyloglucosidase, of special purity, and from 0.1 to 1.8% of endo-poly-galactorunase, at between 38 and 95 degrees C., from 12 to 60 hours, according to the progress of the reaction, such treatment at a pH between 3.5 and 7. Subsequently the mass is heated to between 65 and 110 degrees C., maintaining that temperature during 5 minutes.

Subsequently, it is added from 0.1 to 1.6% of AMT 12.L of s=amylase and the mass is maintained at between 38 and 80 degrees C. for 12 to 72 hours, controlling that the pH is maintained between 3.5 and 7. Then heat to 50 to 90 C during 15 to 12??? minutes and cool to 20 to 45 C.

Subsequently, the obtained product is carefully filtered with the possible addition of filer aid granules.

After filtration the liquid passing through the filter is evaporated at low temperatures in a hybrid type falling film evaporator, with a final effect for high concentrations, which is described in this invention as “Apparatus I”. This apparatus has been developed by the inventors for the purposes of and as part of this invention.

In this evaporation stage a filtration step has been included to reduce impurities that may have been carried over, and after that it is followed by the next evaporation stage.

For these final filtrations one filter with an activated carbon bed and another with an intermediate ion-exchange column have been designed. In this way the purity of the final product is increased. Instead of doing these operations in a conventional way, for this invention we designed a system an apparatus arrangement which provided us, after considerable experimentation, with greatly improved results.

So, instead of presenting only one bed of each of the above-mentioned classes, we found, after many trials, that best results were obtained when passing through an ion-exchange bed, then through a carbon bed and then through a homogeneous mix of 32 to 65% ion-exchange resin and 68 to 35% activated carbon. A series of filtrations were carried out through these 3 beds, with intermediate resin regeneration, until the desired effect was achieved.

By this procedure, sustained results of 46 to 81% content of mono-, di- and polysaccharides on a dry-fruit solids basis, have been achieved.

Additionally to the described method, we have made a series of experiments with diverse enzymes and resins, with several fruits and with a great number of variations in temperature, pH levels and reaction times, which are to be considered part of this invention.

The equipment that allows the fruit pulp extraction was designed and built under our own design and specifications, and once built it was tested and improved in its mechanical and operative design. The equipment we now possess incorporates these improvements and is the one described for in this patent.

Some fruits tend to produce sugars contaminated with dark-color generating products; in this regard we many trials and established that our method allows the obtaining of sugars which maintain clear colors.

Additionally, it was also shown by variations in additives, temperature, pH and times, that the yields and costs can vary widely, a finding that must be regarded as an important part of the description of this invention.

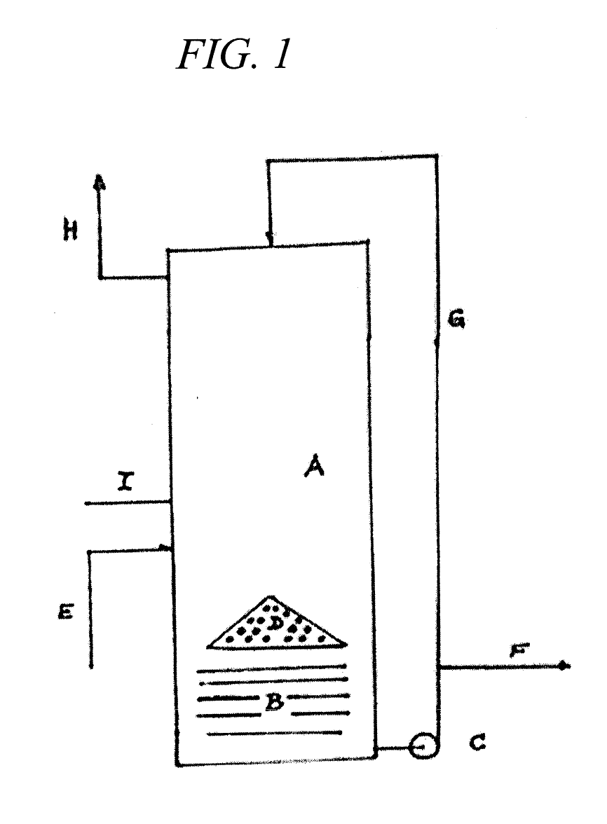

We attach as FIG. 1 the drawing of Apparatus I, an evaporator which patent is being hereby requested. The following details can be appreciated:

A. Evaporation chamber and vapor separation

B. Heat exchanger

C. Recirculation pump

D. Exchanger protection

E. Feed pipe or reception of semi-concentrated liquid from a previous effect

F. Finished product pipe

G. Recirculation pipe

H. Vapor to condenser pipe

I. Pressure regulation pipe

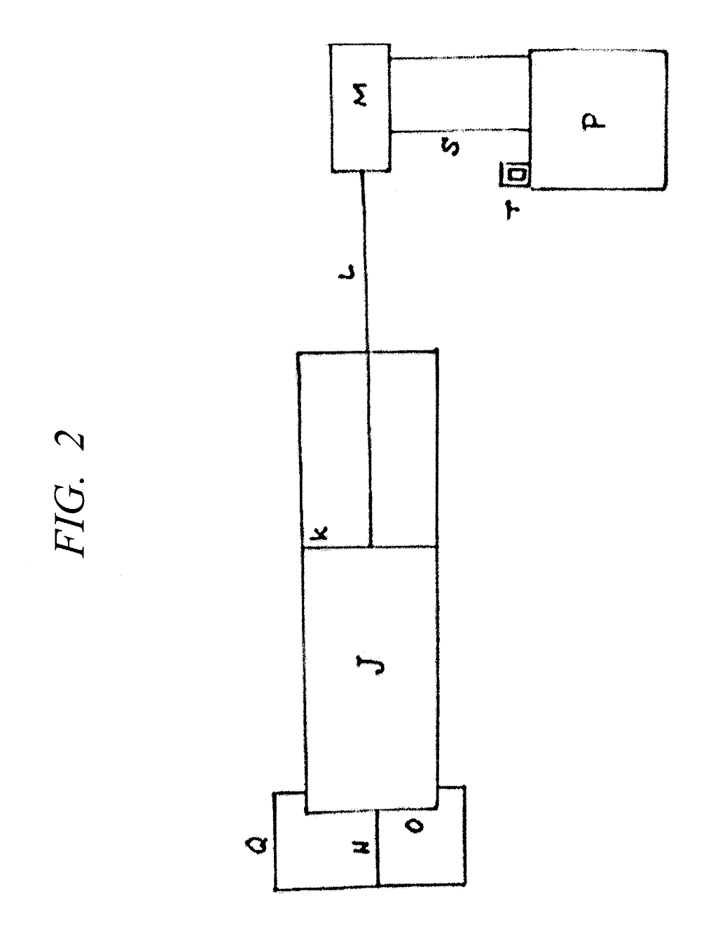

We also attached as FIG. 2 the design of Apparatus II for the extraction of fruit pulp or juice, which patent is hereby being applied for. The following details can be noticed: (To avoid confusion in the drawings, parts identifications for this Apparatus being with the letter J.)

J. Press work-chamber, where the fruit to be extracted is loaded

K. Pressure piston

L. Piston stemp

M. Piston pressure cylinder

N. ?Discharge gate retention bolt

O. Chamber outlet retention gate

P. Press hydraulic equipment

Q. Gate system support

R. Hydraulic pressure hose

S. Hydraulic return hose

T. Automatic control system

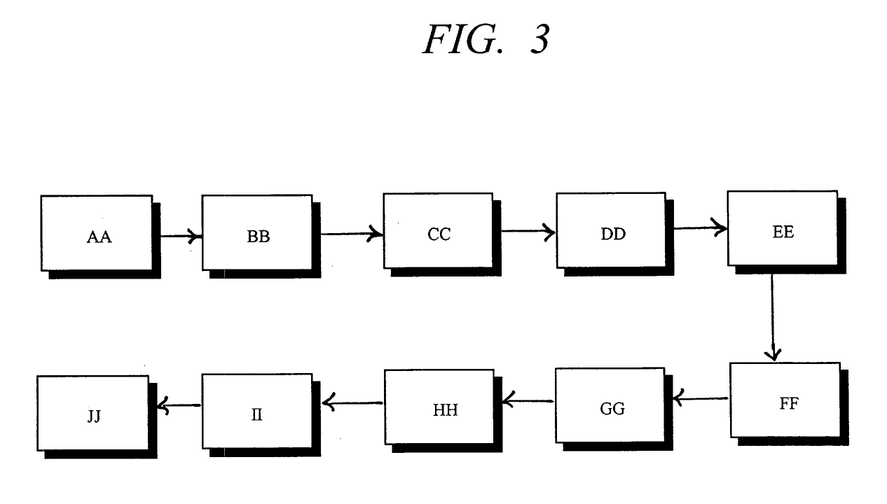

To facilitate the understanding of the system, a diagram of the procedure that constitutes this invention has been included as FIG. 3. Its parts are:

AA. Apparatus II: juice or pulp extraction press

BB. Product transfer pump to storage tanks

CC. Processing tanks

DD. Product to filters transfer pump

EE. Multi-chamber filter for solids separation

FF. Filtered product transfer pump

GG. Diluted product storage tanks

HH. Transfer pump to evaporators

II. Multi-effect evaporator. Last effect is Apparatus I

JJ. Concentrated product to storage tanks pump.

One embodiment of the invention is an enzymatic and with resins extraction, in an oxidant medium and with controlled acidity and temperature, starting with fruit pulps and obtaining glucose syrup, in proportions which depend on the fruit used.

Another embodiment of the invention is a procedure described for obtaining of yellow colored glucose syrup from ripe bananas. This procedure is very special and different from any previous work, due to the new apparatus and systems employed, which are herein described.

A further embodiment of the invention is the incorporation to the process of Apparatus I consisting of a machine that may work along or be incorporated as part of a chain of evaporative effects forming a multi-effect evaporator. The reason why a patent is justified is that the design and operation of such apparatus, as conceived by its inventors, is special and substantially different from any other evaporator in the market. This apparatus was designed specifically for this project.

Still another embodiment of the invention is the design and incorporation to the process of Apparatus I for the extraction of fruit pulp, press-type capable of extracting the juices or the pulp of several fruits, in an efficient and fast way.

Still a further embodiment of the invention is an economical industrial process and not laboratory level experimental theory.

Yet another embodiment of the invention is a process, since it utilized enzymes and resins, which were non-existent for this type of application until relatively few years ago, and which we have applied to this product family to obtain the final products, hereby obtained for the first time, with the proportion and mix of enzymes used in this process which possess a flexibility in such proportion which makes it particular.

Yet a further embodiment of the invention is the capacity for the obtaining of a number of products which are similar but each on applicable to a different use, according to their natural formulation composition, a direct product of the obtaining process. The mentioned products are glucose syrups, which can be concentrated above 85 Brix degrees.

Having described our invention in such terms as to enable those of skill in the art to make and practice the invention, and having described the presently preferred embodiments thereof, we claim:

1. An extraction process comprising the steps of
(a) providing a fruit pulp;
(b) providing an oxidant medium; and,
(c) combining the fruit pulp and the oxidant medium.
